(19) United States
(12) Patent Application Publication
(10) Pub. No.: US 2009/0239111 A1
(43) Pub. Date: Sep. 24, 2009

(54) Fuel Cell Humidifier and Fuel Cell System Having the Same

(76) Inventor: Yixin Zeng, Aichi (JP)

Correspondence Address: KENYON & KENYON LLP, 1500 K STREET N.W., SUITE 700, WASHINGTON, DC, 20005, US

(21) Appl. No.: 11/887,422

(22) PCT Filed: Mar. 29, 2006
(86) PCT No.: PCT/JP2006/307177

§ 371 Date: Dec. 28, 2007

(30) Foreign Application Priority Data
Mar. 31, 2005 (JP) 2005-105128

(51) Int. Cl. H01M 8/04

(52) U.S. Cl. 429/26; 429/34

(57) ABSTRACT

A fuel cell humidifier for performing humidification via a water exchange film by bringing together supplied gas to be supplied to a fuel cell, and off-gas discharged from the fuel cell. The fuel cell humidifier includes: a humidification cell having a supplied gas passage for allowing the supplied gas to flow through, an off-gas passage for allowing the off-gas to flow through, and the water exchange film; and a gas flow cell for allowing either the fuel gas or the off-gas to flow through. The invention provides a fuel cell humidifier, and a fuel cell system equipped with the fuel cell humidifier, that can appropriately adjust the humidification value and the heat exchange amount, prevent humidification characteristics from being influenced by ambient temperature changes, and exhibit enhanced reliability, stability and control.

### TECHNICAL FIELD

The present invention relates to a fuel cell humidifier used for a fuel cell, and to a fuel cell system equipped with the fuel cell humidifier.

### BACKGROUND ART

There is a type of fuel cell humidifier, conventionally used for a fuel cell, that exchanges moisture between off-gas discharged from a fuel cell and gas (or reactant gas) supplied to the fuel cell via a water vapor exchange film.

An example of such a fuel cell humidifier, JP-A-6-132038, discloses a reactant gas humidifier including a water vapor permeation film, and a humidifying gas chamber and a humidified gas chamber defined by the water vapor permeation film. This reactant gas humidifier humidifies reactant gas where the reacted off-gas discharged from the fuel cell is a humidifying gas and the reactant gas (or supplied gas) to be supplied to the fuel cell is a humidified gas.

Another example, JP-A-2004-165062, discloses a fuel cell humidifier composed of an anode humidifier including a plurality of hollow fiber membrane modules, and a cathode humidifier including a plurality of hollow fiber membrane modules. This fuel cell humidifier is equipped with a pair of heads holding both ends of the hollow fiber membrane modules, a connecting member for connecting the heads, and a hot water vaporizer for warming the supplied gas (or reactant gas) outlet in the head and the supplied gas inlet in the head.

The output performance of a fuel cell, particularly a solid polymer fuel cell, depends largely on the humidification state of the supplied gas. However, the humidification characteristics of the aforementioned conventional fuel cell humidifiers are easily affected by, for example, the conditions and environment under which they operate. Also, their humidification value can easily change due to load changes in the fuel cells.

Specifically speaking, in the configuration of a conventional fuel cell humidifier, changes in the ambient temperature where the humidification cells or the fuel cell humidifier is located, and other changes, for example, those in the gas flow status caused by water condensation in the fuel cell humidifier due to a reduction of water exchange efficiency between the supplied gas and the off-gas in the fuel cell humidifier, tend to occur easily. Therefore, it is difficult to maintain performance stability. Accordingly, a fuel cell humidifier that cannot be easily affected by internal or external causes such as an output level of a fuel cell, and that can exhibit stable humidification capability is preferable.

In a method for having the supplied gas or the off-gas bypass the fuel cell humidifier according to the opening or closing of a bypass valve, if the bypass valve opens and closes at a high frequency, a bypass valve with an extended practical life is necessary. Moreover, there is the possibility that power consumption owing to the opening and closing action of the bypass valve may increase and system efficiency may decrease.

### DISCLOSURE OF THE INVENTION

This invention was devised in view of the circumstances described above. It is an object of the invention to provide a fuel cell humidifier, and a fuel cell system equipped with the fuel cell humidifier, that can appropriately adjust the humidification value and the heat exchange amount, prevent humidification characteristics from being affected by ambient temperature changes, and exhibit enhanced reliability, stability, and control.

In order to achieve the above-described object, the invention provides a fuel cell humidifier for performing humidification via a water exchange film by bringing together supplied gas to be supplied to a fuel cell, and off-gas discharged from the fuel cell. The fuel cell humidifier includes: a humidification cell including the water exchange film, a supplied gas passage provided on one surface of the water exchange film to allow the supplied gas to flow through, and an off-gas passage provided on the other surface of the water exchange film to allow the off-gas to flow through; and a gas flow unit that is formed independently from the humidification cell, that includes a gas passage connected to either the supplied gas passage or the off-gas passage to allow the supplied gas or the off-gas to flow through, and is placed adjacent to the humidification cell.

In the fuel cell humidifier having the above-described configuration, either the supplied gas or the off-gas flows (or passes) through the gas flow unit. Therefore, neither water exchange nor heat exchange between the off-gas and the supplied gas takes place in the gas flow unit. Consequently, if the off-gas flows through the gas flow unit, off-gas at a temperature almost equivalent to the internal temperature of the fuel cell will be introduced into the gas flow unit. As a result, it is possible to thermally insulate the fuel cell humidifier and prevent heat radiation from the fuel cell humidifier or heat absorption from the ambient environment.

If the off-gas flows through the gas flow unit, and if the gas utilization rate is constant, the amount of off-gas flowing through the humidification cells decreases by the amount of off-gas passing through the gas passage (or bypassing the humidification cells). Accordingly, the supplied gas amount increases relative to the off-gas amount in the humidification cells, and the relative ratio of the supplied gas to the off-gas can be increased. Consequently, the water exchange efficiency ratio of the fuel cell humidifier (the ratio of water [mol/sec] used to humidify the supplied gas via the water exchange film to water [mol/sec] in the off-gas) can be increased, i.e., the ratio of water used to humidify the supplied gas to water in the off-gas can be brought closer to 1:1. Therefore, water can be exchanged efficiently between the supplied gas and the off-gas in the humidification cells. As a result, it is possible to prevent water condensation (something that would happen if water exchange in the humidification cells were conducted insufficiently), and to enhance operational stability of the fuel cell humidifier.

Meanwhile, if the supplied gas flows through the gas flow unit, the supplied gas, whose temperature has become high to a certain degree through compression by, for example, a pump or a compressor causing the supplied gas to flow, passes through the gas flow unit. Accordingly, in this case as well, it is possible to thermally insulate the fuel cell humidifier and prevent heat radiation from the fuel cell humidifier or heat absorption from the ambient environment.

The gas flow unit can be composed of a gas flow cell. This gas flow cell can be placed side by side with at least either the supplied gas passage or the off-gas passage of the humidification cell. Moreover, the gas flow cell may be placed at one end or both ends of the humidification cell. If the gas flow cells are placed at both ends of the humidification cell, heat radiation from the ends of the humidification cell can be prevented more effectively.

Also in the fuel cell humidifier according to this invention, a plurality of humidification cells may be placed side by side with each other and the gas flow cell may be placed within the humidification cells. In addition to the advantageous effects mentioned above, the above-described arrangement can further enhance the heat retaining property of the fuel cell humidifier and perform water exchange in the humidification cells more efficiently.

Furthermore, the gas flow cell may be placed at least at one end of the humidification cell in the direction perpendicular to the direction of the side-by-side alignment of the humidification cells. In this case, the gas flow cell can have a flow port for allowing the supplied gas or the off-gas to flow through, and the flow port can be provided independently from the supplied gas inlet and supplied gas outlet of the humidification cell. If the humidification cells are piled together in their side-by-side alignment direction, the flow port can constitute a gas flow manifold.

This invention provides a fuel cell system including: a fuel cell; a gas supply passage for supplying supplied gas to the fuel cell; a gas discharge passage for allowing off-gas discharged from the fuel cell to pass through; and the fuel cell humidifier described above.

The fuel cell system having the above-described configuration can thermally insulate the fuel cell humidifier and prevent heat radiation from the fuel cell humidifier and heat absorption from the ambient environment. The fuel cell system can also conduct water exchange efficiently in the humidification cells.

Moreover, the fuel cell system according to the invention can be configured so that the gas discharge passage branches off between the fuel cell and the fuel cell humidifier, and a branch flow member for distributing the off-gas to a branch passage is provided. In this case, the branch flow member is, for example, a valve, and the off-gas can be made to flow into the branch passage according to the opening or closing of the valve.

This configuration allows excessive off-gas to be discharged from the branch passage. Therefore, it is possible to change the amount of off-gas introduced to the fuel cell humidifier according to changes in the load (such as changes in the gas flow rate) on the fuel cell, and to control the humidification value in the fuel cell humidifier. When this happens, since the gas flow unit (or gas flow cell) can absorb the excessive amount of off-gas (or have the off-gas bypass the humidification cells) while the valve is closed (that is, while the off-gas does not flow into the branch passage), the valve operation frequency can be reduced. Accordingly, the practical life of the valve can be extended. Also, the robustness of the control of the humidification value can be enhanced. When the valve is open, the total sum of the amount of off-gas discharged from the branch passage and the amount of off-gas passing through the gas flow unit represents the actual bypass amount. Therefore, the amount of off-gas discharged from the branch passage, i.e., the amount of off-gas passing through the valve can be reduced. As a result, it is unnecessary to use a valve with a large bore and it is possible to conserve the power required to drive the valve.

The branch flow member may be placed in the branch passage, or at a position in the gas discharge passage downstream from a point where the gas discharge passage branches into the branch passage. Also, the branch flow member may be placed at a point where the gas flow passage branches into the branch passage. In this case, the branch flow member may be a three-way valve.

Since neither water exchange nor heat exchange between the off-gas and the supplied gas takes place in the gas flow unit of the fuel cell humidifier according to the invention, it is possible to thermally insulate the fuel cell humidifier and prevent heat radiation from the fuel cell humidifier and heat absorption from the ambient environment. As a result, any influence ambient temperature changes may have on the humidification characteristics can be prevented. Moreover, water exchange can be conducted efficiently in the humidification cells. As a result, it is possible to provide a fuel cell humidifier with enhanced reliability, stability, and control.

The fuel cell system according to the invention can thermally insulate the fuel cell humidifier, and prevent heat radiation from the fuel cell humidifier and heat absorption from the ambient environment. Moreover, water exchange can be conducted efficiently in the humidification cells. As a result, it is possible to provide a fuel cell system with enhanced reliability, stability, and control.

### BRIEF DESCRIPTION OF THE DRAWINGS

FIG. 1 is a sectional view of a fuel cell humidifier according to the first embodiment of this invention.

FIG. 2 is a sectional view of part of a humidification cell belonging to the fuel cell humidifier shown in FIG. 1.

FIG. 3 is a sectional view of part of the humidification cell and a gas flow cell belonging to the fuel cell humidifier shown in FIG. 1.

FIG. 4 is a plan view of the inner surface of the gas flow cell shown in FIG. 3.

FIG. 5 is a schematic diagram illustrating part of a fuel cell system equipped with the fuel cell humidifier shown in FIG. 1.

FIG. 6 is a schematic diagram illustrating flows of supplied gas and off-gas in the fuel cell humidifier shown in FIG. 1.

FIG. 7 is a sectional view of a fuel cell humidifier according to another embodiment of the invention.

FIG. 8 is a schematic view illustrating part of a fuel cell system according to the second embodiment of the invention.

FIG. 9 is a chart showing the relationship between the humidification value for the supplied air and the supply air temperature in the fuel cell system according to the second embodiment.

FIG. 10 is a flowchart explaining valve control for the fuel cell system according to the second embodiment.

FIG. 11 is a chart showing the relationship between the valve status of the fuel cell system and the flow rate (actual bypass flow rate) of discharged air that does not pass through humidification cells, according to the second embodiment.

FIG. 12 is a chart showing the relationship between the valve status of a conventional fuel cell system and the flow rate (actual bypass flow rate) of discharged air that does not pass through the humidification cells in that fuel cell system.

FIG. 13 is a sectional view of a fuel cell humidifier according to another embodiment of the invention.

FIG. 14 is a plan view of the inner surface of a gas flow cell shown in FIG. 13.

FIG. 15 is a schematic view illustrating part of a fuel cell system according to yet another embodiment of the invention.

FIG. 16 is a schematic view illustrating part of a fuel cell system according to a further embodiment of the invention.

### BEST MODE FOR CARRYING OUT THE INVENTION

A fuel cell humidifier and a fuel cell system equipped with the fuel cell humidifier according to preferred embodiments of this invention are described below in detail with reference to the attached drawings. The embodiments described below are for the purpose of describing this invention, but the invention is not limited only to these embodiments. Accordingly, this invention can be utilized in various ways unless the utilizations depart from the gist of the invention.

### First Embodiment

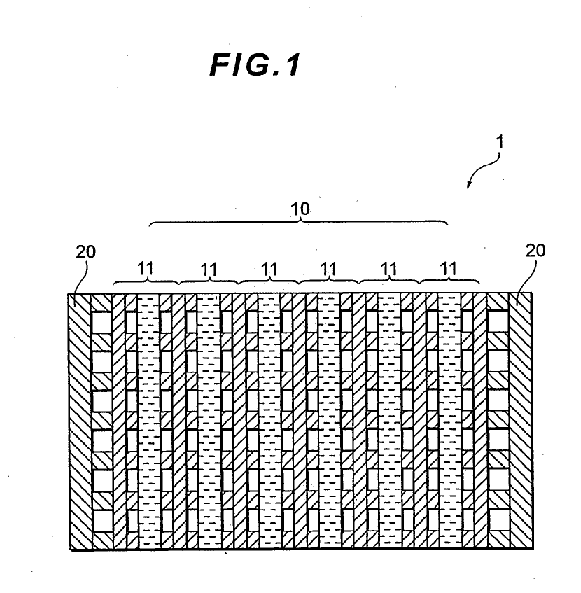

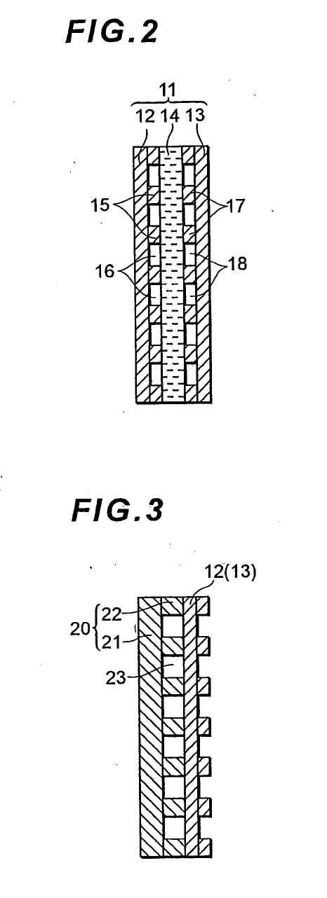

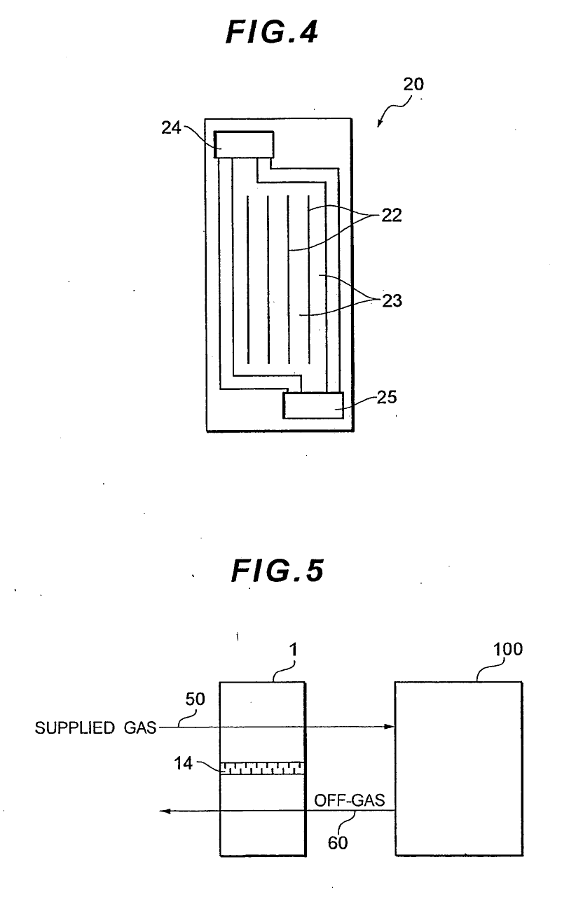

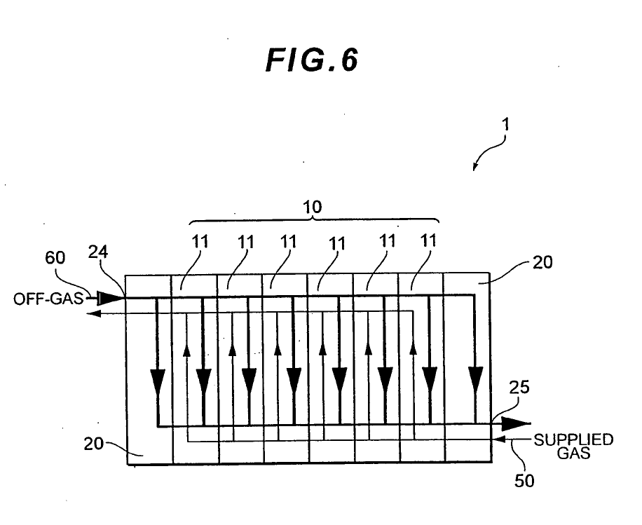

FIG. 1 is a sectional view of a fuel cell humidifier according to the first embodiment of this invention. FIG. 2 is a sectional view of part of a humidification cell belonging to the fuel cell humidifier shown in FIG. 1. FIG. 3 is a sectional view of part of the humidification cell and a gas flow cell belonging to the fuel cell humidifier shown in FIG. 1. FIG. 4 is a plan view of the inner surface of the gas flow cell shown in FIG. 3. FIG. 5 is a schematic diagram illustrating part of a fuel cell system equipped with the fuel cell humidifier shown in FIG. 1. FIG. 6 is a schematic diagram illustrating flows of supplied gas and off-gas in the fuel cell humidifier shown in FIG. 1.

A fuel cell humidifier 1 according to the first embodiment is incorporated into a fuel cell system as shown in FIG. 5. The fuel cell humidifier 1 is connected to a supply source (not shown in the drawing) for supplied gas and is also connected to a gas supply passage 50 for supplying the supplied gas (oxidized gas and/or fuel gas), and to a gas discharge passage 60 for discharging off-gas ejected from a fuel cell 100.

As shown in FIGS. 1 to 4, the fuel cell humidifier 1 includes: a humidification cell group 10 composed of a plurality of humidification cells 11 installed side by side; and gas flow cells 20 placed at both ends of the humidification cell group along the direction of the side-by-side alignment of the humidification cells 11.

As shown in FIG. 2, the humidification cell 11 includes: a supplied gas passage board 12 for allowing the supplied gas from the fuel cell 100 (see FIG. 5) to flow through; an off-gas passage board 13 placed opposite the supplied gas passage board 12, for allowing the off-gas discharged from the fuel cell 100 to flow through; and a water exchange film 14 interposed between the supplied gas passage board 12 and the off-gas passage board 13.

On the surface of the supply gas passage board 12 facing the water exchange film 14, a plurality of partitions 15 are placed parallel to each other, with a certain distance between adjacent partitions 15. These partitions 15 form a plurality of supply gas passages 16 (many parallel grooves). On the surface of the off-gas passage board 13 facing the water exchange film 14, a plurality of partitions 17 are placed parallel to each other, with a certain distance between adjacent partitions 17. These partitions 17 form a plurality of off-gas passages 18 (many parallel grooves). The supply gas passage board 12 and the off-gas passage board 13 are preferably made of metals, carbons, plastic, resins, rubber or the like.

The water exchange film 14 serves to exchange moisture between the supplied gas and the off-gas, and may preferably be composed of an ion exchange resin film, or a porous film or the like.

The gas flow cell 20 is composed of a gas passage board 21, as specifically shown in FIG. 3. On the surface of the gas passage board 21 facing the humidification cell 11, a plurality of partitions 22 are placed parallel to each other, with a certain distance between adjacent partitions 22. These partitions 22 form a plurality of gas passages 23. Moreover, as shown in FIG. 4, a gas inlet 24 connected to the gas passages 23 and a gas outlet 25 for discharging the gas that has been introduced from the gas inlet 24 and passed through the gas passages 3 are formed in the gas flow cell 20.

The gas inlet 24 for the gas flow cell 20 is connected either the gas supply passage 50 or the gas discharge passage 60. Consequently, either the supplied gas or the off-gas flows through the gas passages 23. The first embodiment is designed so that the gas inlet 24 is connected to the gas discharge passage 60 (see FIG. 6) and only the off-gas flows through the gas passages 23.

Specifically speaking, the off-gas is introduced from the gas inlet 24 of the gas flow cell 20 and off-gas inlets (not shown) of the respective humidification cells 11 as shown in FIG. 6. On the other hand, the supplied gas is introduced from supplied gas inlets (not shown) belonging to the respective humidification cells 11. As explained above, only the off-gas, and not the supplied gas, is introduced into the gas flow cells 20 according to the first embodiment. This means that the supplied gas is introduced into the respective humidification cells 11 without passing through the gas flow cells 20. On the other hand, both the off-gas and the supplied gas are introduced into the respective humidification cells 11, where moisture exchange between the supplied gas and the off-gas is conducted via the water exchange film 14.

The off-gas introduced into the gas flow cell 20 flows through the gas passages 23 and is then discharged externally from the gas outlet 25. Therefore, neither heat exchange nor water exchange between the off-gas and the supplied gas takes place in the gas flow cell 20. As a result, since the off-gas, at a temperature almost equivalent to that of the internal temperature of the fuel cell 100, flows within the gas flow cell 20, it is possible to thermally insulate the fuel cell humidifier 1. It is also possible to prevent heat radiation from the ends of the fuel cell humidifier 1 or heat absorption from the ambient environment.

Moreover, in the fuel cell humidifier 1, the amount of off-gas supplied to the humidification cells 11 decreases by the amount of off-gas passing through the gas flow cell 20 gas passage 23 (or the amount of off-gas bypassing the humidification cells 11). Accordingly, the amount of supplied gas in the humidification cells 11 increases relatively, so that the relative ratio of the supplied gas to the off-gas increases. Consequently, in the fuel cell humidifier 1, the ratio of water [mol/sec] used to humidify the supplied gas to water [mol/sec] in the off-gas can be brought closer to 1:1. Therefore, water can be exchanged efficiently between the supplied gas and the off-gas in the humidification cells 11. As a result, it is possible to prevent generation of condensed water in the humidification cells 11 and enhance the operational stability of the fuel cell humidifier 1.

Also, in the fuel cell humidifier 1 according to the first embodiment, configured in such a way that the gas flow cell 20 is placed at both ends of the humidification cell group 10, the proportion of the amount of off-gas flowing through the gas flow cells 20 to the total amount of off-gas changes depending on an increase or decrease in the off-gas flow rate caused by uneven flow distribution rates of the humidification cells 11. Therefore, the fuel cell humidifier 1 can autonomously respond to changes in the off-gas flow rate caused by load changes.

Incidentally, the fuel cell humidifier 1 according to this invention may be placed in an oxidant gas system in order to humidify an oxidant gas, or be placed in a fuel gas system in order to humidify a fuel gas. Also, the fuel cell humidifier 1 may be placed in both the oxidant gas system and the fuel gas system in order to humidify both the oxidant gas and the fuel gas.

The first embodiment described the gas inlet 24 of the gas flow cell 20 connected to the gas discharge passage 60 so that only the off-gas flows through the gas passages 23. However, the invention is not limited to the above-described configuration, and the fuel cell humidifier 1 may be configured so that the gas inlet 24 is connected to the gas supply passage 50, and only the supplied gas flows through the gas passages 23.

The first embodiment also described one gas flow cell 20 placed at both ends of the humidification cell group 10. However, the invention is not limited to the above-described configuration, and a plurality of gas flow cells 20 may be placed side by side as desired. Also, the positions of the gas flow cells 20 are not particularly limited.

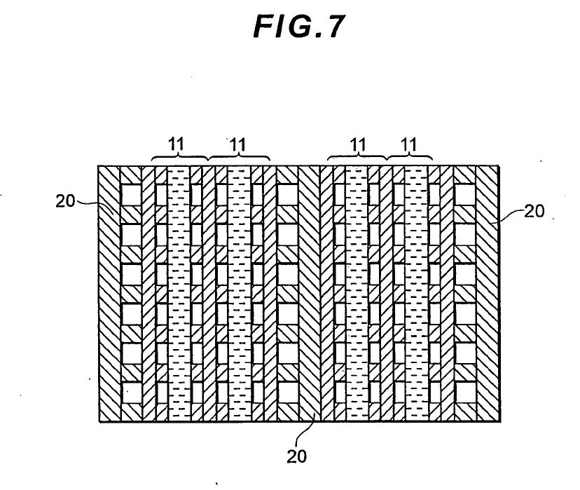

For example, the gas flow cell 20 may be placed within the humidification cell group 10 as shown in FIG. 7. Referring to FIG. 7, the gas flow cell 20 is located in the middle of the humidification cell group 10. However, the positions of the gas flow cells 20 are not limited to the above-described example, and the gas flow cells 20 and the humidification cells 11 may be placed alternately or a gas flow cell 20 may be inserted every certain number of humidification cells 11, for example, one gas flow cell 20 every two or three humidification cells 11. When a gas flow cell 20 is placed in a humidification cell group 10, a gas flow cell 20 may not necessarily be placed at both ends of the humidification cell group 10. As described above, the heat retaining property of the fuel cell humidifier 1 can be further enhanced by placing the gas flow cell(s) 20 in the humidification cell group 10. Also, the water exchange in the humidification cells 11 can be conducted more efficiently.

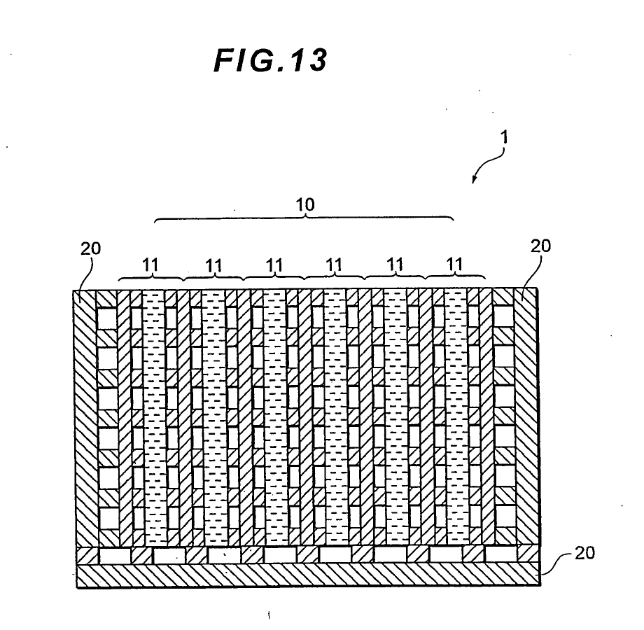

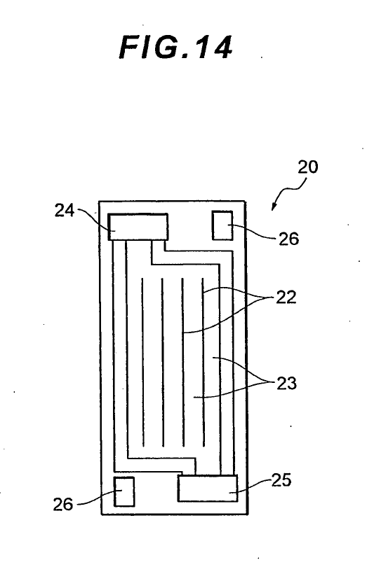

Furthermore, the first embodiment described gas flow cells 20 placed at both ends of the humidification cell group 10 along the direction of the side-by-side alignment of the humidification cells 11. However, the positions of the gas flow cells 20 are not limited to those in the above-described example, and the gas flow cells 20 may be placed at the end of the humidification cell group 10 in the direction perpendicular to the direction of the side-by-side alignment of the humidification cells 11, as shown in FIG. 13. In this case, as shown in FIG. 14, flow ports 26 for allowing the supplied gas or the off-gas to flow through may be formed independently from the supplied gas inlet 24 and the supplied gas outlet 25 of the humidification cell 11. The flow ports 26 formed independently from the supplied gas inlet and the supplied gas outlet of the humidification cell 11 serve as gas flow manifolds when the humidification cells 11 are piled together.

### Second Embodiment

Next, a fuel cell system according to the second embodiment of this invention will be described with reference to the relevant drawings. The elements used in the second embodiment the same as those explained in the first embodiment are given the same reference numerals as in the first embodiment, and any detailed description thereof is omitted.

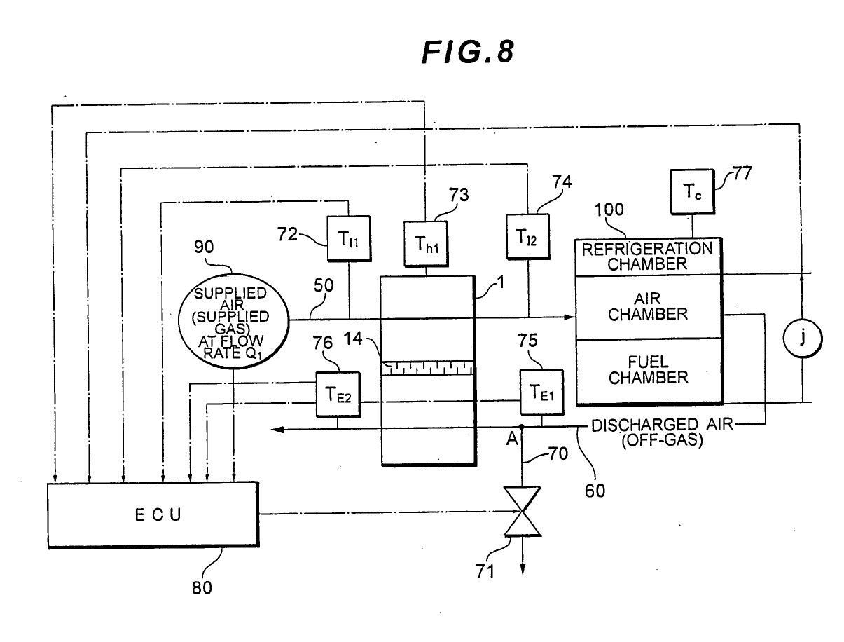

FIG. 8 is a schematic view illustrating part of a fuel cell system according to the second embodiment of the invention. The second embodiment describes the case where the fuel cell humidifier 1 explained in the first embodiment is placed in an oxidant gas system in order to humidify an oxidant gas (or air).

As shown in FIG. 8, the difference between the fuel cell system according to the second embodiment and the fuel cell system according to the first embodiment is point A (branch point A) between the fuel cell 100 and the fuel cell humidifier 1, where the gas discharge passage 60 branches off at the branch point A and a valve 71 is provided in a branch passage 70.

In this fuel cell system, a temperature sensor 72 is placed in the gas supply passage 50 at a position upstream of the fuel cell humidifier 1 in order to measure the temperature Tₗ₁ of the supplied air (or supplied gas) passing there. A temperature sensor 73 is placed at the fuel cell humidifier 1 in order to measure the surface temperature Tₕ₁ of the fuel cell humidifier 1. Also, a temperature sensor 74 is placed in the gas supply passage 50 at a position downstream of the fuel cell humidifier 1 in order to measure the temperature Tₗ₂ of the supplied air discharged from the fuel cell humidifier 1.

Meanwhile a temperature sensor 75 is placed in the gas discharge passage 60 at a position downstream of the fuel cell 100 and upstream of the branch point A in order to measure the temperature T_{E1} of the discharged air (or off-gas) ejected from the fuel cell 100. Also, a temperature sensor 76 is placed in the gas discharge passage 60 at a position downstream of the fuel cell humidifier 1 in order to measure the temperature T_{E2} of the discharged air ejected from the fuel cell humidifier 1.

Furthermore, a temperature sensor 77 for measuring refrigerant temperature is placed at the fuel cell 100 in order to measure the temperature T_{c} of a refrigerant.

This fuel cell system includes a control unit (ECU) 80. This control unit 80 receives the temperatures measured by the respective temperature sensors 72 to 77 and controls the opening and closing of the valve 71 according to these temperatures.

In the fuel cell system with the above-described configuration, the supplied air (or supplied gas) provided by an air supply source 90 is introduced via the gas supply passage 50 into, and humidified by, the fuel cell humidifier 1, and then supplied to the fuel cell 100. Fuel gas is also supplied from a fuel gas system (not shown) to the fuel cell 100. An electrochemical reaction occurs at the fuel cell 100 that receives these gases, and the fuel cell 100 discharges the high-temperature and high-humidity air (off-gas) to the gas discharge passage 60. Unreacted hydrogen is also discharged to the gas discharge passage of the fuel gas system (not shown).

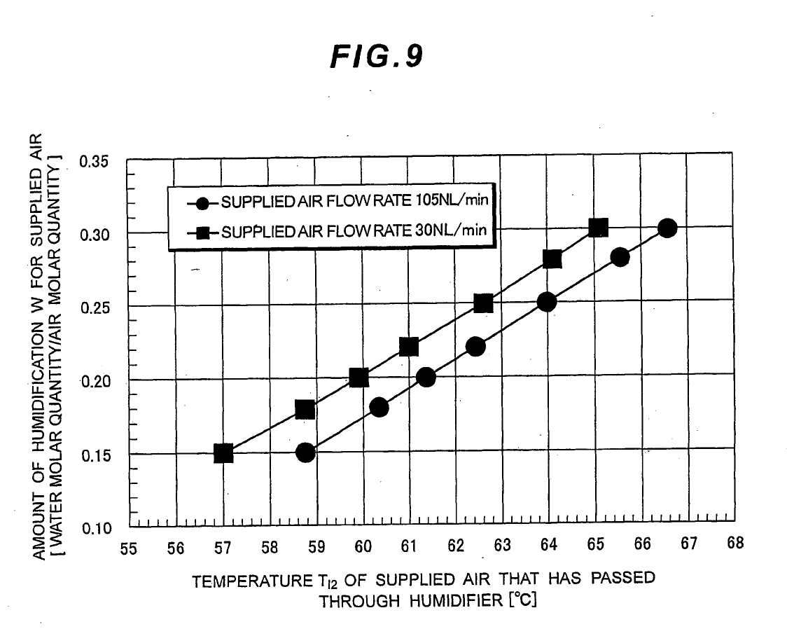

The high-temperature and high-humidity air discharged to the gas discharge passage 60 is introduced into the fuel cell humidifier 1. The fuel cell humidifier 1 performs water exchange and heat exchange to transfer moisture and heat from the discharged air to the supplied air via the water exchange film 14. The discharged air is then ejected from the fuel cell humidifier 1 into the gas discharge passage 60. In the water exchange and the heat exchange, the amount of heat exchange to the supplied air increases based on an increase in the amount of water exchanged. In other words, correlations are found between the temperature Tₗ₂ of the supplied air discharged from the fuel cell humidifier 1 and the humidification value W for the supplied air, as shown in FIG. 9.

Referring to FIG. 9, it is apparent that the relationship between the humidification value W and the temperature Tₗ₂ changes depending on the supplied air flow rate Q₁. When the temperature Tₗ₁ of the supplied air introduced into the fuel cell humidifier 1, the surface temperature Tₕ₁ of the fuel cell humidifier 1, and the refrigerant temperature T_{c} of the fuel cell 100 are maintained at constant values under specified conditions, the temperature Tₗ₂ of the supplied air ejected from the fuel cell humidifier 1 is an indicator of the humidification value W for the supplied air. Specifically speaking, the above relationship is represented by the following formula:

Tₗ₂=f(W,Tₗ₁,Tₕ₁,T_{c},Q₁) [Formula 1]

Because of the same reason, the temperature T_{E2} of the discharged air that has passed through the fuel cell humidifier 1 is also a control target value for the humidification value W for the supplied air. Specifically speaking, that relationship is represented by the following formula:

T_{E2}=f(W,Tₗ₁,Tₕ₁,T_{c},Q₁) [Formula 1]

The humidification value W for the supplied air, and the temperature Tₗ₂ or T_{E2} as the control target value for the humidification value W are controlled by opening and closing the valve 71 placed in the branch passage 70. As the amount of discharged air passing through the branch passage 70 (or bypassing the humidification cells 11) increases, the net amount of the discharged air introduced into the respective humidification cells 11 (or the humidification cell group 10) of the fuel cell humidifier 1, giving moisture and heat to the supplied air decreases, and the humidification value W for the supplied air then decreases proportionately under the influence of the decrease in the net amount of discharged air. As the net amount of the discharged air decreases, the amount of heat exchanged between the discharged air and the supplied air also decreases proportionately. As a result, the temperature Tₗ₂ of the supplied air that has passed through the fuel cell humidifier 1, or the temperature T_{E2} of the discharged air that has passed through the fuel cell humidifier 1 decreases according to the decrease in the net amount of discharged air passing through the humidification cell group 10 of the fuel cell humidifier 1. For the same reason, when the amount of discharged air passing through the valve 71 (or bypassing the humidification cells 11) is reduced, the temperature Tₗ₂ of the supplied air that has passed through the fuel cell humidifier 1, or the temperature T_{E2} of the discharged air that has passed through the fuel cell humidifier 1 increases.

The valve 71 may be a variable valve or an on/off valve. If the valve 71 is a variable valve, the size of the valve 71 opening is adjusted to a specified level so that the temperature Tₗ₂ or T_{E2} required by the humidification value in order to humidify the supplied air reaches a control target value T_{lW}. As a result, it is possible to obtain the amount of discharged air that should bypass the humidification cells 11 and pass through the branch passage 70, and to secure the requested required humidification value for the supplied air.

On the other hand, if the valve 71 is an on/off valve, the opening and closing of the valve 71 is controlled so that the temperature Tₗ₂ or T_{E2} required by the humidification value in order to humidify the supplied air becomes the control target value or enters a control target range. If the temperature Tₗ₂ is used for this control, it is apparent from FIG. 9 that when the temperature Tₗ₂ is 60° C.≦Tₗ₂≦62° C., the humidification value W for the supplied air corresponds to a molar ratio of 0.18 to 0.22. Accordingly, the control unit (ECU) 80 controls the valve 71, opening it when the temperature Tₗ₂ reaches 62° C., and closing it when the temperature Tₗ₂ becomes lower than 60° C., so that the humidification value W corresponding to a molar ratio of 0.18 to 0.22 will be applied to the supplied air.

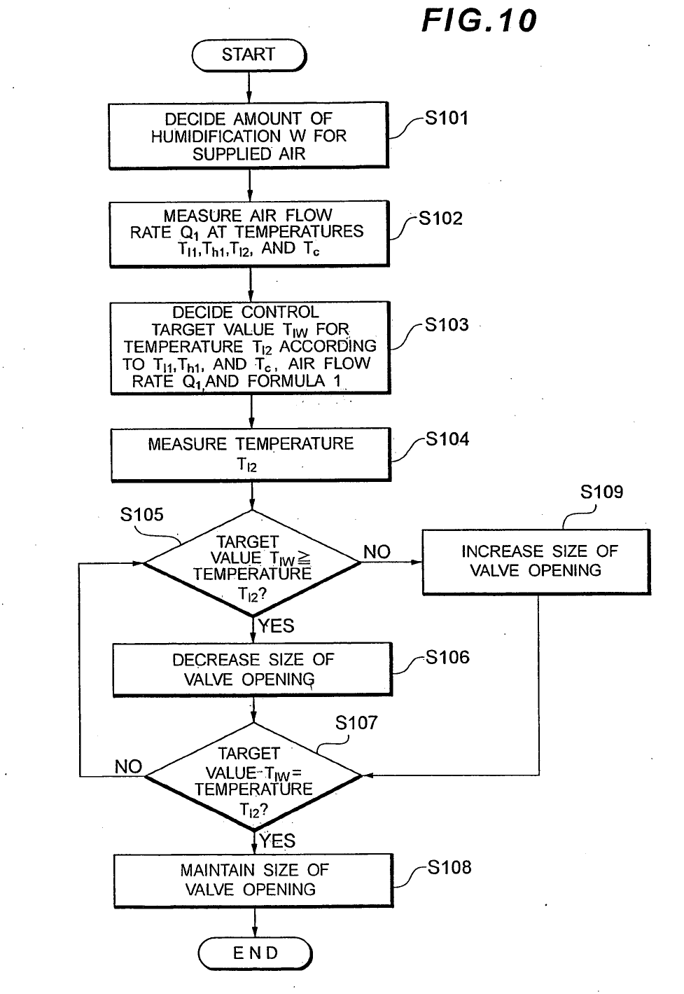

Next, the case where the valve 71 is a variable valve and the size of the valve 71 opening is controlled will be described in more detail by using the value of the temperature Tₗ₂ and referring to the flowchart in FIG. 10.

First, the required humidification value W for the supplied air in the fuel cell humidifier 1 is input into the control unit (ECU) 80 (step S101). When the values Tₗ₁, Tₕ₁ and T_{c} measured by the respective temperature sensors 72, 73 and 77, as well as the supplied air flow rate Q₁ are input into the control unit (ECU) 80 (step S102), the control unit (ECU) 80 applies these values to the aforementioned formula 1 and decides on the control target value T_{lW} for the temperature Tₗ₂ of the supplied air that has passed through the fuel cell humidifier 1 (S103).

Subsequently, the temperature sensor 74 measures the temperature Tₗ₂ of the supplied air that has passed through the fuel cell humidifier 1, and the obtained value (actual measurement value) is then input into the control unit (ECU) 80 (step S104).

The control unit (ECU) 80 compares the control target value T_{lW} with the temperature Tₗ₂ (step S105). If the temperature Tₗ₂ is lower than the control target value T_{lW} (step S105: YES), the control unit (ECU) 80 controls the valve 71, decreasing the size of the valve 71 opening (step S106). The control unit (ECU) 80 then judges whether or not the temperature Tₗ₂ is the same value as the control target value T_{lW} (step S107). If the temperature Tₗ₂ is the same value as the control target value T_{lW} (step S107: YES), the control unit (ECU) 80 maintains the size of the valve 71 opening (step S108). On the other hand, if the temperature Tₗ₂ is not the same value as the control target value T_{lW}, the processing returns to step S105 (step S107: NO).

If the temperature Tₗ₂ is higher than the control target value T_{lW} at step S105 (step S105: NO), the control unit (ECU) 80 controls the valve 71, to increasing the size of the valve 71 opening (step S109). The control unit (ECU) 80 then judges whether or not the temperature Tₗ₂ is the same value as the control target value T_{lW} (step S107). If the temperature Tₗ₂ is the same value as the control target value T_{lW} (step S107: YES), the control unit (ECU) maintains the size of the valve 71 opening (step S108). On the other hand, if the temperature Tₗ₂ is not the same value as the control target value T_{lW}, the processing returns to step S105 (step S107: NO).

If the valve 71 is an on/off valve, the control unit (ECU) 80 judges whether the temperature Tₗ₂ is within the range of the lower and upper limits of the control target value T_{lW} or whether the temperature Tₗ₂ has exceeded the upper limit of the control target value T_{lW}. If the temperature Tₗ₂ is within the range of the lower and upper limits of the control target value T_{lW}, the control unit (ECU) 80 controls the valve 71, closing it. If the temperature Tₗ₂ has exceeded the upper limit of the control target value T_{lW}, the control unit (ECU) 80 controls the valve 71, opening it.

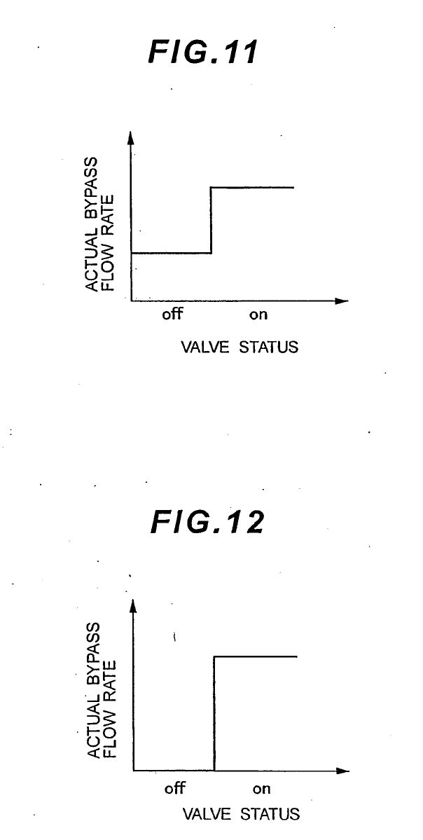

In the fuel cell system according to the second embodiment, the fuel cell humidifier 1 and the valve 71 placed in the branch passage 70 control the amount of discharged air to be introduced into the respective humidification cells 11 (or the humidification cell group 10). The gas flow cell 20 in the fuel cell humidifier 1 is like a bypass passage that is always open. Accordingly, as shown in FIG. 11, the closed state (or the OFF state) of the valve 71 is set so that the discharged air will be supplied to the fuel cell humidifier 1 at a maximum flow rate (in a full load state). Therefore, the operation mode using the valve 71 with low discharged air flow rates can be employed. As a result, the operational stability, water exchange efficiency, and heat exchange efficiency of the fuel cell humidifier 1 can be enhanced.

On the other hand, if a conventional fuel cell humidifier having no gas flow cell 20 is used instead of the fuel cell humidifier 1, the humidification value for the supplied air is controlled only by the opening and closing of the valve 71. If so, as shown in FIG. 12, a wider range of the air supply amount to the fuel cell 100 or the required humidification value according to a load level can be applied. In order to respond to the full range of the required humidification value, the flow rate of discharged air passing through the branch passage 70 ranges from several NL/min to several tens of NL/min. Therefore, a valve with a large bore and larger valve drive power are required, and there is the possibility that responsiveness or controllability may degrade when the discharged air flow rate is low. There is also the possibility that pressure fluctuations may increase owing to flow fluctuations in the discharged air, thereby adversely affecting auxiliary machines, such as an air blower.

The second embodiment described the control target value T_{lW} for the temperature Tₗ₂ of the supplied air that has passed through the fuel cell humidifier 1 as decided according to formula 1. However, without limitation to this example, the case where a control target range indicating a certain range for the control target value T_{lW} may be decided and whether the temperature Tₗ₂ (actual measurement value) is within the control target range or not is judged is also possible.

Moreover, according to the second embodiment, the situation where a control target value T_{EW} or a control target range for the discharged air that has passed through the fuel cell humidifier 1 may be decided according to the aforementioned formula 2, and whether the temperature T_{E2} (actual measurement value) is the same as the control target value T_{EW} or within the control target range or not is judged is also possible.

The fuel cell humidifier 1 and the valve 71 according to this invention may be placed in an oxidant gas system or a fuel gas system, or they may be placed in both the oxidant gas system and the fuel gas system.

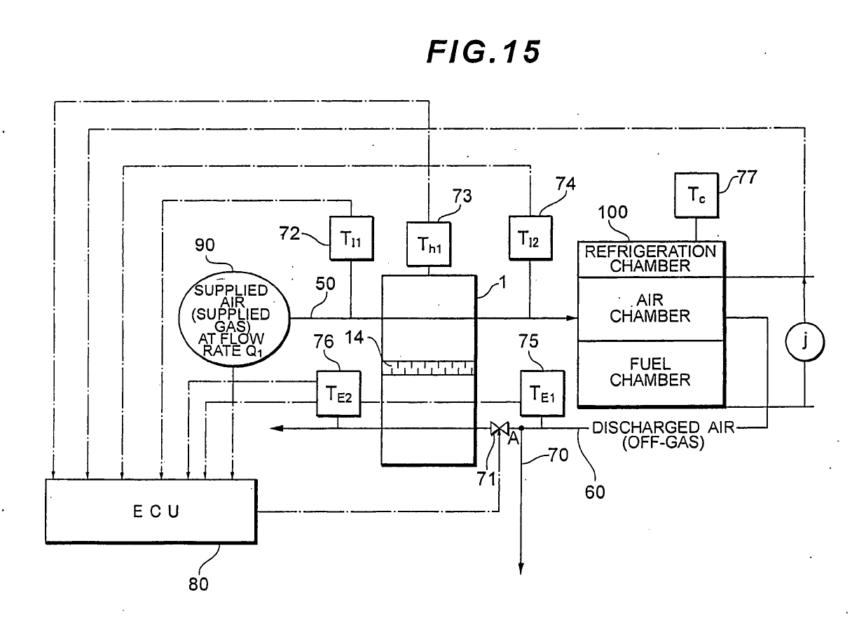

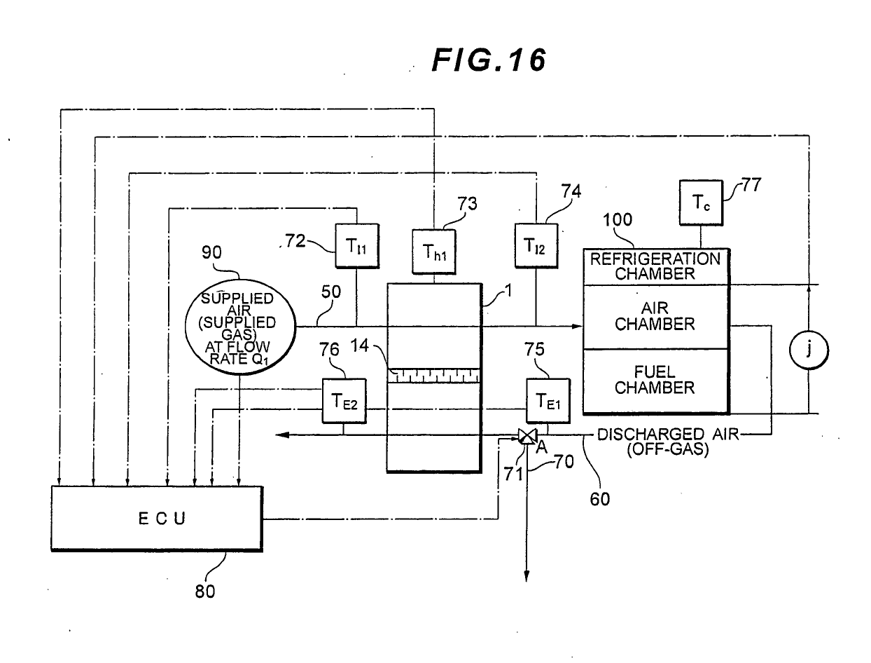

Furthermore, the second embodiment described the valve 71 placed in the branch passage 70. However, the position of the valve 71 is not limited to that in the above-described example, and the valve 71 may be placed at a position in the gas discharge passage 60 downstream from the branch point A as shown in FIG. 15. Also, a three-way valve may be placed at the branch point A as shown in FIG. 16.

1. A fuel cell humidifier for performing humidification via a water exchange film by bringing together supplied gas to a fuel cell, and off-gas discharged from the fuel cell, the fuel cell humidifier comprising:
a humidification cell including the water exchange film, a supplied gas passage provided on one surface of the water exchange film to allow the supplied gas to flow through, and an off-gas passage provided on the other surface of the water exchange film to allow the off-gas to flow through; and
a gas flow unit formed independently from the humidification cell, that includes a gas passage connected to either the supplied gas passage or the off-gas passage to allow the supplied gas or the off-gas to flow through, and is placed adjacent to the humidification cell.

2. The fuel cell humidifier according to claim 1, wherein the gas flow unit is a gas flow cell.

3. The fuel cell humidifier according to claim 2, wherein the gas flow cell is placed side by side with at least either the supplied gas passage or the off-gas passage of the humidification cell.

4. The fuel cell humidifier according to claim 3, wherein the gas flow cell is placed at least at one end of the humidification cell.

5. The fuel cell humidifier according to claim 2, wherein a plurality of humidification cells are placed side by side with each other and the gas flow cell is placed within the humidification cells.

6. The fuel cell humidifier according to claim 2, wherein the gas flow cell is placed at least at one end of the humidification cell in the direction perpendicular to the direction of side-by-side alignment of the humidification cells.

7. The fuel cell humidifier according to claim 6, wherein the gas flow cell has a flow port for allowing the supplied gas or the off-gas to flow through, the flow port provided independently from a supplied gas inlet and a supplied gas outlet belonging to the humidification cell.

8. The fuel cell humidifier according to claim 7, wherein the humidification cells are piled together in their side-by-side alignment direction, and the flow port constitutes a gas flow manifold.

9. A fuel cell system comprising:
a fuel cell;
a gas supply passage for supplying supplied gas to the fuel cell;
a gas discharge passage for allowing off-gas discharged from the fuel cell to pass through; and
the fuel cell humidifier according to claim 1.

10. The fuel cell system according to claim 9, wherein the gas discharge passage branches off between the fuel cell and the fuel cell humidifier, and a branch flow member for distributing the off-gas to a branch passage is provided.

11. The fuel cell system according to claim 10, wherein the branch flow member is a valve, and the off-gas flows through the branch passage according to the opening and closing of the valve.

12. The fuel cell system according to claim 10, wherein the branch flow member is placed in the branch passage.

13. The fuel cell system according to claim 10, wherein the branch flow member is placed at a position in the gas discharge passage downstream from a point where the gas discharge passage branches into the branch passage.

14. The fuel cell system according to claim 10, wherein the branch flow member is placed at a point where the gas discharge passage branches into the branch passage, and the branch flow member is a three-way valve.
